(19) United States
(12) Patent Application Publication
(10) Pub. No.: US 2011/0123720 A1
(43) Pub. Date: May 26, 2011

(54) METHOD FOR PAINTING A PLASTIC POWDER PRODUCT

(75) Inventor: Tiao-Tang LI, Taipei County (TW)

(73) Assignee: Govern General International Co., Ltd., Taipei County (TW)

(21) Appl. No.: 12/625,566

(22) Filed: Nov. 25, 2009

(51) Int. Cl. B05D 1/04; B29C 45/00

(52) U.S. Cl. 427/483; 264/105

(57) ABSTRACT

A method for painting a plastic powder product includes the steps of: adding a conductive material into engineering plastics; high pressure injection molding the engineering plastics with the conductive material in a module to manufacture a plastic powder product; surface treating the plastic powder product for removing oil stains and inks from the plastic powder product, an electrostatic gun spraying paint on the plastic powder product; baking the plastic powder product in an ultraviolet oven for hardening the plastic powder product at a temperature between 90. degree. C. and 120. degree. C. for about 3 to 15 minutes.

### BACKGROUND OF THE INVENTION

1. Field of the Invention

The present invention relates to a method, and more particularly to a method for painting a plastic powder product, and cooperated to a UV baking technology for hardening the product in a 90-120 degree. C. environment.

2. Description of Related Art

In the past, a product casing, such as a computer casing or a laptop casing, is painted with various patterns, like a three-dimensional design. These patterns may be printed or be dyed. It is not easy to paint on the plastic product. A conventional method for painting is one color painting, injection molding with color powder, spray painting, gilding, vacuum baking varnish, or electroplating. However, the patterns are unable to meet expectations.

A conventional method for painting a plastic product has a procedure for baking the plastic product to harden the product. The baking temperature is about 120-220° C. However, the plastic product is deformed, or the strength of the product is reduced due to the baking temperature is high.

The present invention has arisen to mitigate and/or obviate the disadvantages of the conventional method.

### SUMMARY OF THE INVENTION

The main objective of the present invention is to provide an improved method for painting a plastic powder product.

To achieve the objective, the method for painting a plastic powder product in accordance with the present invention comprises a conductive material, such as graphite, carbon, black mica, or elemental carbon, added into engineering plastics, such as nylon, ABS, AS, PS, PP, PE, PA, PC, POM, PPE, PC+ABS, PPO, TPU, PVC, PET, PBT, PBT+fiberglass, PA+fiberglass, ABS+fiberglass, or PC+fiberglass. The conductive material and the engineering plastics are guided into a module and injection molded to manufacture a plastic powder product. An electrostatic gun sprays paint on the plastic powder product such that the paint is electrified and is easily attached on the plastic powder product.

The method for painting a plastic powder product in according to the present invention comprising the following steps: adding a conductive material into engineering plastics; high pressure injection molding the engineering plastics with the conductive material in a module to manufacture a plastic powder product; surface treating the plastic powder product for removing oil stains and inks from the plastic powder product, an electrostatic gun spraying paint on the plastic powder product; and baking the plastic powder product in an ultraviolet oven for hardening the plastic powder product at a temperature between 90. degree. C. and 120. degree. C. for about 3 to 15 minutes such that a finished product is manufactured. The ultraviolet baking can be applied to various plastic materials having low temperature resistance. More plastic materials can apply the method in according with the present invention. The plastic materials are not easily deformed and the strength of the plastic materials are not reduced.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of a method for paint a plastic power product in accordance with the present invention;

FIG. 2 is a procedural diagram of the method for paint a plastic power product in accordance with the present invention; and

FIG. 3 is a procedural diagram of a second embodiment of the method for paint a plastic power product in accordance with the present invention.

### DETAILED DESCRIPTION OF THE INVENTION

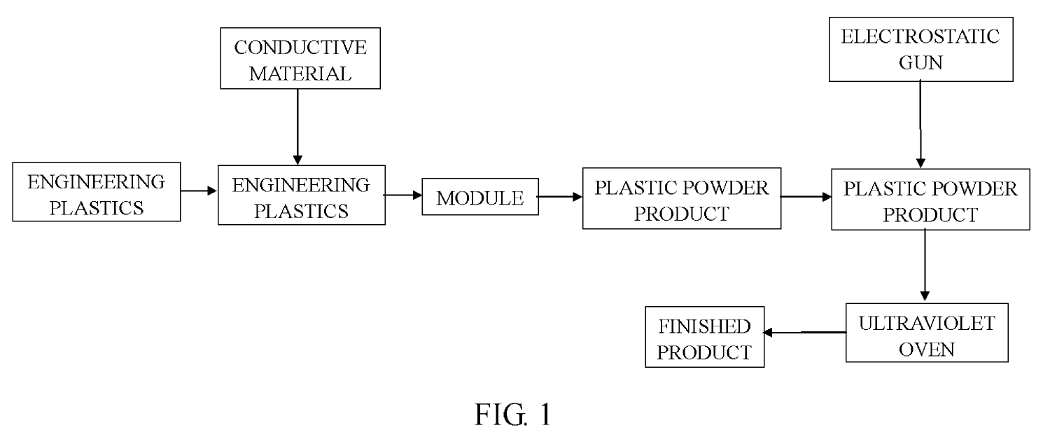

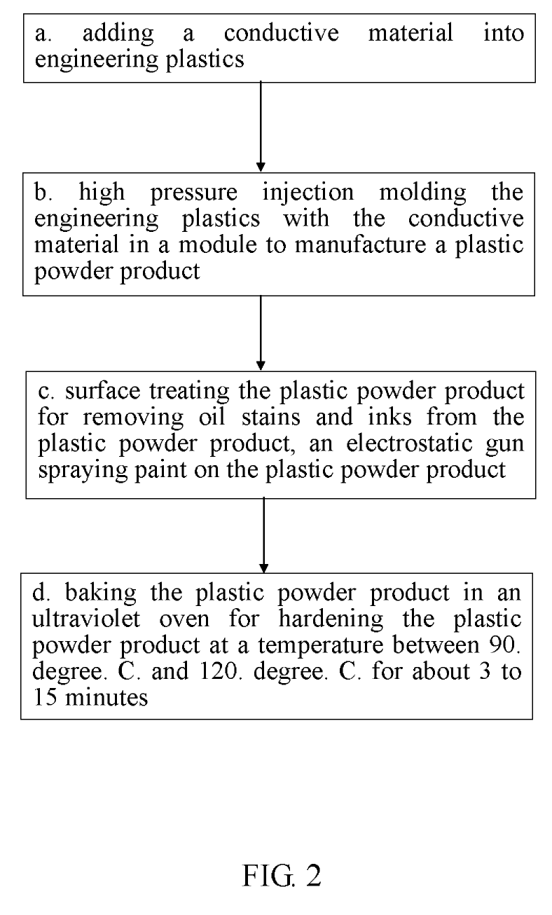

Referring to the drawings and initially to FIGS. 1-2, a method for painting a plastic powder product in accordance with the present invention comprises engineering plastics. The engineering plastics 10 can comprises at least one of nylon, ABS, AS, PS, PP, PE, PA, PC, POM, PPE, PC+ABS, PPO, TPU, PVC, PET, PBT, PBT+fiberglass, PA+fiberglass, ABS+fiberglass, or PC+fiberglass. A conductive material 12 is added into the engineering plastics 10. Based on a manufacture cost, a proportion of the conductive material 12 is less than 20%. The conductive material 12 comprises at least one of graphite, carbon, black mica, or elemental carbon. The conductive material 12 and the engineering plastics 10 are guided into a module 14 and injection molded to manufacture a plastic powder product 16. After the plastic powder product 16 is cooled down and is molded, an electrostatic gun 18 sprays paint (not shown) on the plastic powder product 16. The paint is electrified due to the electrostatic gun 18. The plastic powder product 16 is baked in an ultraviolet oven 20 and baked by ultraviolet light for hardening the plastic powder product 16 at a temperature between 90. degree. C. and 120. degree. C. for about 3 to 15 minutes such that a finished product 22 is manufactured. The electrostatic gun 18 has a conductivity between 10-1000000000000 ohm. The paint can be a powdery paint or a liquid paint. A conventional baking paint has a thickness of 30 μm. The paint on the plastic powder product 16 of the method in according to the present invention has a thickness between 60-120 μm. The paint is firmly attached on the plastic powder product 16.

The method for painting a plastic powder product in according to the present invention comprising the following steps:

a. adding a conductive material 12 into engineering plastics 10;

b. high pressure injection molding the engineering plastics 10 with the conductive material 12 in a module 14 to manufacture a plastic powder product 16;

c. surface treating the plastic powder product 16 for removing oil stains and inks from the plastic powder product 16, an electrostatic gun 18 spraying paint on the plastic powder product 16; and

d. baking the plastic powder product 16 in an ultraviolet oven 20 for hardening the plastic powder product 16 at a temperature between 90. degree. C. and 120. degree. C. for about 3 to 15 minutes such that a finished product 22 is manufactured.

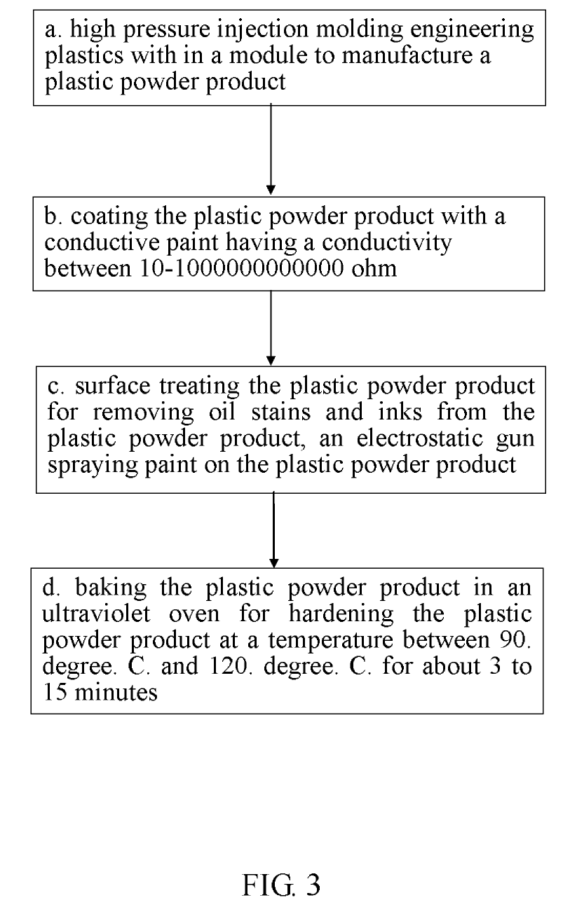

With reference to FIG. 3, that shows a second embodiment of the method for painting a plastic powder product in accordance with the present invention. The elements and effects of the second embodiment which are the same with the first embodiment are not described, only the differences are described. The method for painting a plastic powder product of the second embodiment in according to the present invention comprising the following steps:

a. high pressure injection molding engineering plastics 10 with in a module 14 to manufacture a plastic powder product 16;

b. coating the plastic powder product 16 with a conductive paint having a conductivity between 10-1000000000000 ohm;

c. surface treating the plastic powder product 16 for removing oil stains and inks from the plastic powder product 16, an electrostatic gun 18 spraying paint on the plastic powder product 16; and

d. baking the plastic powder product 16 in an ultraviolet oven 20 for hardening the plastic powder product 16, the baking temperature being about 90 to 120 degree. C. for about 3 to 15 minutes such that a finished product 22 is manufactured.

Although the invention has been explained in relation to its preferred embodiment, it is to be understood that many other possible modifications and variations can be made without departing from the spirit and scope of the invention as hereinafter claimed.

What is claimed is:

1. A method for painting a plastic powder product comprising the steps of:
a. adding a conductive material into engineering plastics;
b. high pressure injection molding the engineering plastics with the conductive material in a module to manufacture a plastic powder product;
c. surface treating the plastic powder product for removing oil stains and inks from the plastic powder product, an electrostatic gun spraying paint on the plastic powder product; and
d. baking the plastic powder product in an ultraviolet oven for hardening the plastic powder product at a temperature between 90. degree. C. and 120. degree. C. for about 3 to 15 minutes.

2. The method for painting a plastic powder product as claimed in claim 1, wherein the engineering plastics comprises at least one of nylon, ABS, AS, PS, PP, PE, PA, PC, POM, PPE, PC+ABS, PPO, TPU, PVC, PET, PBT, PBT+fiberglass, PA+fiberglass, ABS+fiberglass, or PC+fiberglass.

3. The method for painting a plastic powder product as claimed in claim 1, wherein the conductive material comprises at least one of graphite, carbon, black mica, or elemental carbon.

4. The method for painting a plastic powder product as claimed in claim 1, wherein the paint is sprayed by the electrostatic gun such that the paint is electrified and is easily attached on the plastic powder product.

5. The method for painting a plastic powder product as claimed in claim 1, wherein the electrostatic gun has a conductivity between 10-1000000000000 ohm.

6. The method for painting a plastic powder product as claimed in claim 1, wherein the paint comprises at least one of a powdery paint or a liquid paint.

7. The method for painting a plastic powder product as claimed in claim 1, wherein paint on the plastic powder product has a thickness between 60-120 μm.

8. A method for painting a plastic powder product comprising the steps of:
a. high pressure injection molding engineering plastics with in a module to manufacture a plastic powder product;
b. coating the plastic powder product with a conductive paint having a conductivity between 10-1000000000000 ohm;
c. surface treating the plastic powder product for removing oil stains and inks from the plastic powder product, an electrostatic gun spraying paint on the plastic powder product; and
d. baking the plastic powder product in an ultraviolet oven for hardening the plastic powder product at a temperature between 90. degree. C. and 120. degree. C. for about 3 to 15 minutes.
